(19) United States
(12) Patent Application Publication
(10) Pub. No.: US 2024/0313908 A1
(43) Pub. Date: Sep. 19, 2024

(54) HYBRID AUTOMATIC REPEAT REQUEST STATE DISCARDING

(71) Applicant: QUALCOMM Incorporated, San Diego, CA (US)

(72) Inventors: Leena ZACHARIAS, San Jose, CA (US); Arnaud MEYLAN, San Diego, CA (US); Deepak WADHWA, San Diego, CA (US); Sitaramanjaneyulu KANAMARLAPUDI, San Diego, CA (US); Levent AYDIN, San Diego, CA (US); Hobin KIM, San Diego, CA (US)

(21) Appl. No.: 18/352,063

(22) Filed: Jul. 13, 2023

Related U.S. Application Data
(60) Provisional application No. 63/490,991, filed on Mar. 17, 2023.

(51) Int. Cl. H04L 1/1867; H04W 72/232; H04W 76/28

(52) U.S. Cl. CPC H04L 1/188; H04W 72/232; H04W 76/28

(57) ABSTRACT

Various aspects of the present disclosure generally relate to wireless communication. Some aspects more specifically relate to selectively discarding a hybrid automatic repeat request (HARQ) state in association with a HARQ state retention timer or downlink control information (DCI) misdetection information. In some aspects, a user equipment (UE) may discard a HARQ state in association with an expiration of the HARQ state retention timer. Additionally or alternatively, the UE may identify DCI misdetection information that indicates a likelihood that the UE did not receive first DCI transmitted by the network node. The UE may discard the HARQ state in association with the likelihood being greater than a threshold. In some aspects, the UE may receive second DCI that includes an NDI, and may transmit a communication in association with selectively discarding the HARQ state and receiving the DCI.

### CROSS-REFERENCE TO RELATED APPLICATION

This patent application claims priority to U.S. Provisional Patent Application No. 63/490,991, filed on Mar. 17, 2023, entitled “HYBRID AUTOMATIC REPEAT REQUEST STATE DISCARDING,” and assigned to the assignee hereof. The disclosure of the prior application is considered part of and is incorporated by reference into this patent application.

### FIELD OF THE DISCLOSURE

Aspects of the present disclosure generally relate to wireless communication and specifically, to techniques and apparatuses for hybrid automatic repeat request discarding.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

In some cases, a user equipment (UE) may fail to discard a hybrid automatic repeat request (HARQ) state for a given HARQ process. For example, the UE may retain the HARQ state for an indefinite period of time. This may not account for the possibility that the UE and a network node can go out-of-sync with one another. For example, the UE may fail to receive downlink control information (DCI) transmitted by the network node that includes a new data indicator (NDI) and that indicates a change to the HARQ state. In the example of uplink HARQ, the UE may receive first DCI that includes a first NDI, and may perform a new transmission (for example, transmit a communication for a first time) in accordance with the first NDI. At a subsequent time, the UE may receive second DCI that includes a second NDI, the second NDI being different than the first NDI, and may perform one or more retransmissions of the communication in accordance with the second NDI. At another subsequent time, the network node may transmit third DCI that includes a third NDI, the third NDI being different than the second NDI. However, the UE may not receive the third NDI. Thus, the UE may continue to retransmit the communication even though the network node has already received the communication from the UE. This may result in wasted network resources, for example, due to the UE performing unnecessary retransmissions of the communication. Additionally or alternatively, this may result in missed transmission opportunities by the UE since the UE may not perform any new transmissions while the UE is retransmitting the communication that has already been received by the network node.

### SUMMARY

Some aspects described herein relate to a method of wireless communication performed by a user equipment (UE). The method may include selectively discarding a hybrid automatic repeat request (HARQ) state in association with a HARQ state retention timer or downlink control information (DCI) misdetection information associated with first DCI. The method may include receiving second DCI that includes a new data indicator (NDI). The method may include transmitting a communication in association with selectively discarding the HARQ state and receiving the second DCI.

Some aspects described herein relate to a UE for wireless communication. The UE may include at least one memory and at least one processor communicatively coupled with the at least one memory. The at least one processor may be operable to cause the UE to selectively discard a HARQ state in association with a HARQ state retention timer or DCI misdetection information associated with first DCI. The at least one processor may be operable to cause the UE to receive second DCI that includes an NDI. The at least one processor may be operable to cause the UE to transmit a communication in association with selectively discarding the HARQ state and receiving the second DCI.

Some aspects described herein relate to a non-transitory computer-readable medium that stores a set of instructions for wireless communication by a UE. The set of instructions, when executed by one or more processors of the UE, may cause the UE to selectively discard a HARQ state in association with a HARQ state retention timer or DCI misdetection information associated with first DCI. The set of instructions, when executed by one or more processors of the UE, may cause the UE to receive second DCI that includes an NDI. The set of instructions, when executed by one or more processors of the UE, may cause the UE to transmit a communication in association with selectively discarding the HARQ state and receiving the second DCI.

Some aspects described herein relate to an apparatus for wireless communication. The apparatus may include means for selectively discarding a HARQ state in association with a HARQ state retention timer or DCI misdetection information associated with first DCI. The apparatus may include means for receiving second DCI that includes an NDI. The apparatus may include means for transmitting a communication in association with selectively discarding the HARQ state and receiving the second DCI.

Aspects generally include a method, apparatus, system, computer program product, non-transitory computer-readable medium, UE, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating an example disaggregated base station architecture in accordance with the present disclosure.

FIG. 4 is a diagram illustrating an example of hybrid automatic repeat request (HARQ) state discarding, in accordance with the present disclosure.

FIGS. 5A-5B are diagrams illustrating an example process for a HARQ state retention timer, in accordance with the present disclosure.

FIG. 6 is a flowchart illustrating an example process performed, for example, by a UE that supports wireless communications in accordance with the present disclosure.

FIG. 7 is a diagram of an example apparatus for wireless communication that supports wireless communications in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to hybrid automatic repeat request (HARQ) state discarding. Some aspects more specifically relate to selectively discarding a HARQ state in association with a HARQ state retention timer or downlink control information (DCI) misdetection information. Discarding the HARQ state may include deleting or erasing the HARQ state. For example, a user equipment (UE) may set the HARQ state in association with receiving DCI that includes a new data indicator (NDI). Subsequently, the UE may discard (e.g., delete or erase) the HARQ state from a memory of the UE. Thus, the UE may no longer be configured with the HARQ state. In some aspects, the UE may initiate a HARQ state retention timer that indicates a time period during which the UE is to retain the HARQ state. For example, the UE may maintain the HARQ state in a high state, and may perform one or more retransmissions of a communication, for a duration of the HARQ state retention timer. The UE may discard the HARQ state in association with an expiration of the HARQ state retention timer. In some aspects, the UE may identify DCI misdetection information. The DCI misdetection information may indicate a likelihood that the UE did not receive first DCI transmitted by the network node. The DCI misdetection information may be based at least in part on an energy parameter, a cyclic redundancy check parameter, or a prune parameter, among other examples. The UE may discard the HARQ state in association with the likelihood that the UE did not receive the first DCI being greater than a threshold. In some aspects, the UE may receive second DCI that includes an NDI, and may transmit a communication in association with selectively discarding the HARQ state and receiving the DCI. For example, the UE may perform one or more retransmissions of a communication in association with discarding the HARQ state and in accordance with the NDI indicating to perform the one or more retransmissions. Alternatively, the UE may transmit a new communication in association with discarding the HARQ state and in accordance with the NDI indicating to perform the new transmission.

Particular aspects of the subject matter described in this disclosure can be implemented to realize one or more of the following potential advantages. In some examples, the described techniques can be used to improve HARQ state synchronization between the UE and the network node. For example, the UE may discard a HARQ state and, therefore, may transmit a new communication rather than perform one or more retransmissions of a communication that has previously been received by the network node, in association with a HARQ state retention timer or DCI misdetection information. This may reduce a number of wasted network resources resulting from retransmissions of communications that have already been received by the network node. Additionally or alternatively, this may increase a number of new communications that can be transmitted by the UE.

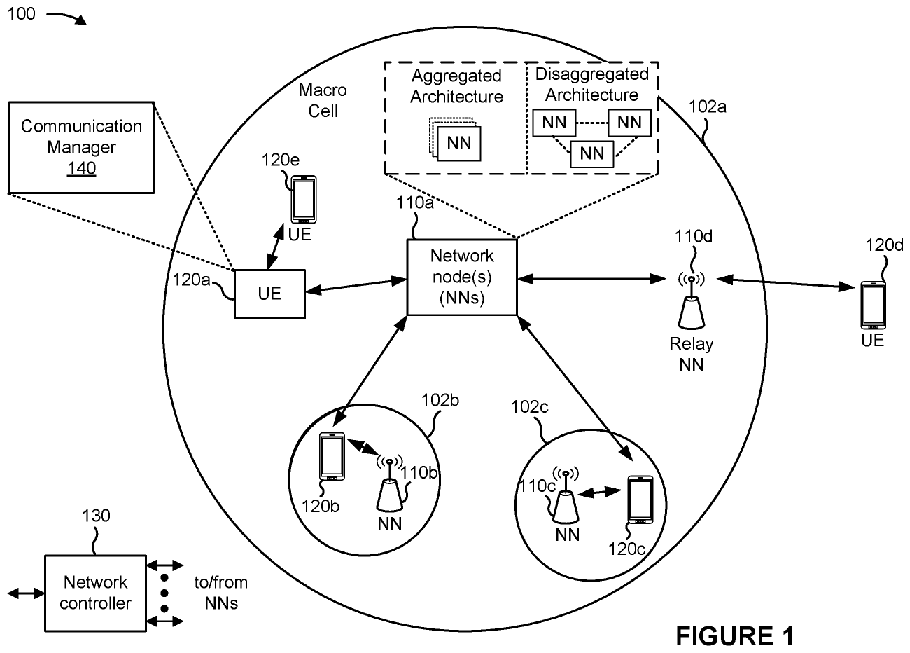

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a UE 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, and/or a RAN node. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), and/or a Non-Real Time (Non-RT) RIC. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

In some examples, a cell may not necessarily be stationary, and the geographic area of the cell may move in accordance with the location of a network node 110 that is mobile (for example, a mobile network node). In some examples, the network nodes 110 may be interconnected to one another or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHZ) and FR2 (24.25 GHZ-52.6 GHz). Although a portion of FR1 is greater than 6 GHZ, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHZ. For example, three higher operating bands have been identified as frequency range designations FR4a or FR4-1 (52.6 GHZ-71 GHZ), FR4 (52.6 GHZ-114.25 GHZ), and FR5 (114.25 GHZ-300 GHz). Each of these higher frequency bands falls within the EHF band.

With the above examples in mind, unless specifically stated otherwise, the term “sub-6 GHZ,” if used herein, may broadly represent frequencies that may be less than 6 GHZ, may be within FR1, or may include mid-band frequencies. Further, unless specifically stated otherwise, the term “millimeter wave.” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may selectively discard a HARQ state in association with a HARQ state retention timer or DCI misdetection information associated with first DCI; receive second DCI that includes an NDI; and transmit a communication in association with selectively discarding the HARQ state and receiving the second DCI. Additionally or alternatively, the communication manager 140 may perform one or more other operations described herein.

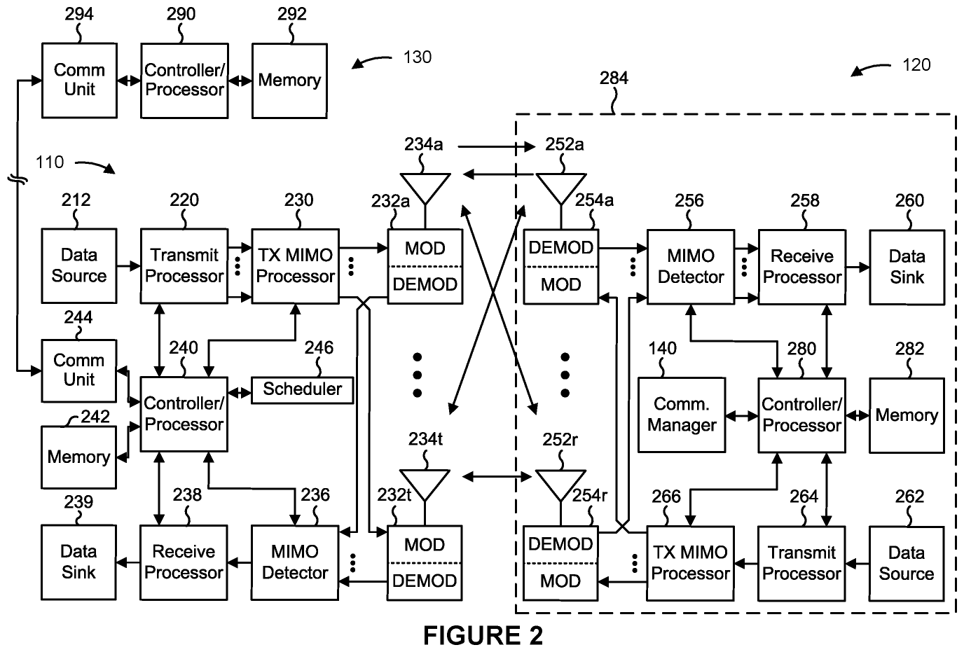

FIG. 2 is a diagram illustrating an example network node in communication with a UE in a wireless network in accordance with the present disclosure. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example. T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers and/or one or more processors. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

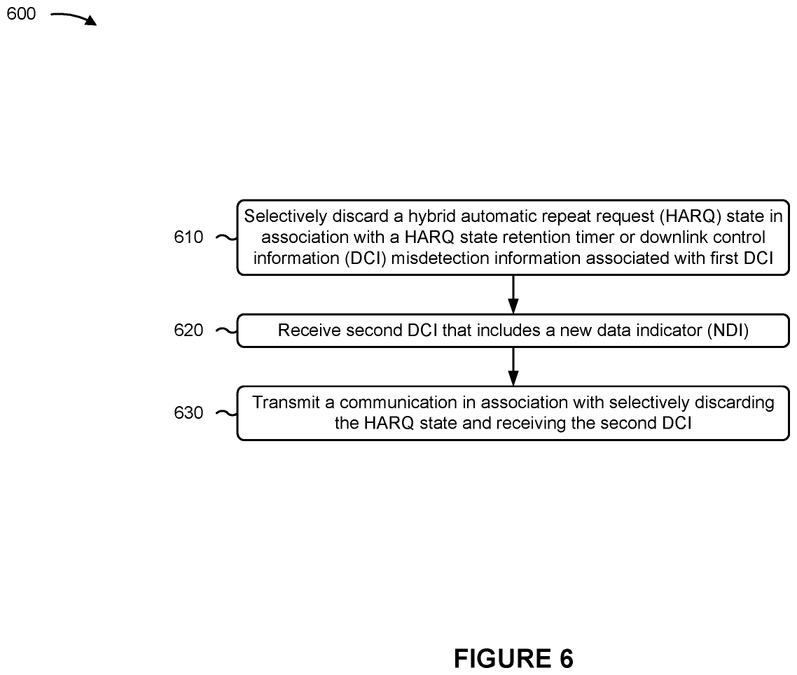

The controller/processor 240 of the network node 110, the controller/processor 280 of the UE 120, or any other component(s) of FIG. 2 may perform one or more techniques associated with HARQ state discarding, as described in more detail elsewhere herein. For example, the controller/processor 240 of the network node 110, the controller/processor 280 of the UE 120, or any other component(s) of FIG. 2 may perform or direct operations of, for example, process 600 of FIG. 6, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 600 of FIG. 6, or other processes as described herein. In some examples, executing instructions may include running the instructions, converting the instructions, compiling the instructions, or interpreting the instructions, among other examples.

In some aspects, the UE 120 includes means for selectively discarding a HARQ state in association with a HARQ state retention timer or DCI misdetection information associated with first DCI; means for receiving second DCI that includes an NDI; and/or means for transmitting a communication in association with selectively discarding the HARQ state and receiving the second DCI. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, and/or one or more RUs).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

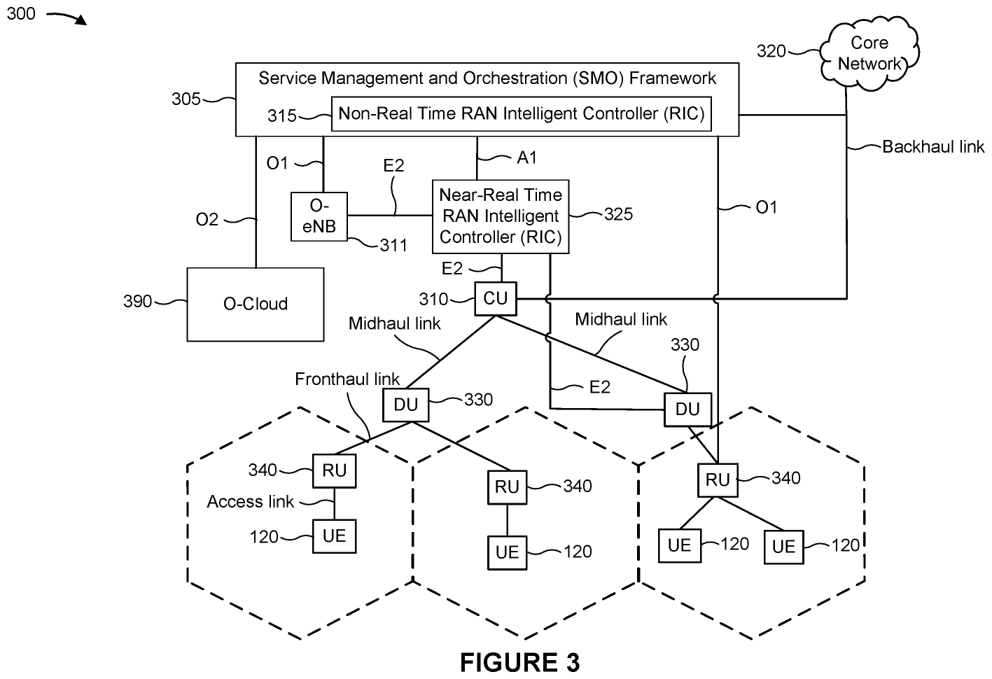

FIG. 3 is a diagram illustrating an example disaggregated base station architecture 300 in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), and/or control plane functionality (for example, Central Unit-Control Plane (CU-CP) functionality). In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

Hybrid automatic repeat request (HARQ) refers to a retransmission protocol in which a receiver wireless communication device checks for errors in received data and, if an error is detected, then the receiver wireless communication device buffers the received data and requests a retransmission from a transmitter wireless communication device. A HARQ receiver is then able to combine the buffered received data with retransmitted data prior to channel decoding and error detection, which improves performance of the retransmission. The HARQ protocol can be implemented at a medium access control (MAC) layer.

The HARQ protocol relies on the transmitter wireless communication device receiving acknowledgements (for example, acknowledgements (ACKs) or negative acknowledgements (NACKS)) from the receiver wireless communication device. The round-trip time, which includes both a processing time of the transmitter wireless communication device and a processing time of the receiver wireless communication device, as well as propagation delays, means that such acknowledgements are not received instantaneously.

In general, the transmitter wireless communication device becomes inactive (with respect to communicating with the receiver wireless communication device) while waiting for an acknowledgment or waiting for a scheduling opportunity, meaning that average throughput may be relatively low. This corresponds to a single HARQ process (also referred to as a stop and wait (SAW) process). A HARQ process stops and waits for an acknowledgment before proceeding to transfer additional data. Multiple HARQ processes can be used to avoid the round-trip time having an impact on throughput. That is, other HARQ processes may transfer data while a given HARQ process is waiting for an acknowledgment. A HARQ entity within the MAC layer manages the multiple HARQ processes. In operation, the transmitter wireless communication device buffers transmitted data until a positive acknowledgment has been received (in case a retransmission is needed). Data is cleared from the transmit buffer once a positive acknowledgment has been received or the maximum number of allowed retransmissions has been reached. New data can be sent by a given HARQ process once its transmit buffer has been cleared.

The HARQ protocol can be used on the downlink or on the uplink. “Downlink HARQ” may refer to the transfer of downlink data on a physical downlink shared channel (PDSCH) with HARQ acknowledgments returned either on a physical uplink control channel (PUCCH) or a physical uplink shared channel (PUSCH). “Uplink HARQ” may refer to the transfer of uplink data on a PUSCH with HARQ acknowledgments returned on a physical downlink control channel (PDCCH). For both downlink HARQ and uplink HARQ, each serving cell has its own HARQ entity and its own set of HARQ processes. Further, both downlink HARQ and uplink HARQ are asynchronous, meaning that there is no fixed timing pattern for each HARQ process. Rather, a network node must signal an identity of a relevant HARQ process with each downlink resource allocation. Notably, while asynchronous HARQ increases signaling overhead, asynchronous HARQ increases flexibility since retransmissions do not have to be scheduled during specific slots.

A dynamic downlink resource allocation can be provided on a PDCCH using downlink control information (DCI) (for example, DCI Format 1_0, DCI Format 1_1). DCI associated with a dynamic downlink resource allocation can include information that enables operation of downlink HARQ, such as information indicating a HARQ process number, a new data indicator (NDI), a redundancy version (RV), a PDSCH-to-HARQ feedback timing indicator, a PUCCH resource indicator, a downlink assignment index (DAI), code block group (CBG) transmission information (CBGTI), CBG flushing information (CBGFI), modulation and coding scheme (MCS) information, or frequency resource allocation information (for example, resource block allocation information), among other examples. Similarly, a dynamic uplink resource allocation can be provided on a PDCCH using DCI (for example, DCI Format 0_0, DCI Format 0_1). DCI associated with a dynamic uplink resource allocation can include information that enables operation of uplink HARQ, such as information indicating a HARQ process number, an NDI, an RV, or CBGTI.

With respect to downlink HARQ, an NDI may be communicated via a single bit used to inform a UE of whether the network node is transmitting a new transmission (for example, a new transport block (TB)) or a retransmission of a previous transmission. Toggling the NDI value relative to a previous NDI value (for example, from 0 to 1, from 1 to 0) for the same HARQ process indicates that a new transmission is being transmitted (rather than a retransmission). Conversely, maintaining (i.e., not toggling) the NDI value relative to a previous NDI value for the same HARQ process indicates that a retransmission is being transmitted (rather than a new transmission).

With respect to uplink HARQ, an NDI can be a one-bit flag that serves as a HARQ acknowledgment for a previous transmission associated with the specified HARQ process number. For example, toggling the NDI value relative to a previous NDI value for the specified HARQ process serves to instruct the UE to initiate a new transmission (this corresponds to a positive acknowledgment of the previous transmission). Conversely, using the same NDI value (i.e., not toggling the NDI value relative to the previous NDI value) for the specified HARQ process serves to instruct the UE to perform a retransmission of the previous transmission (this corresponds to a negative acknowledgment of the previous transmission).

A state of a given HARQ process (herein referred to as a HARQ state) is defined by the NDI value and may include other information associated with performing HARQ transmission/reception, such as an MCS, an RB allocation, and/or timing information associated with the HARQ process at a given time. Thus, a toggling of the NDI value relative to a previous NDI value can be said to cause a HARQ state of the HARQ process to switch from one HARQ state to another HARQ state (for example, from a state 0 when the NDI value is 0 to a state 1 when the NDI value is 1, or vice versa).

In some cases, the UE may fail to discard a HARQ state for a given HARQ process. For example, the UE may retain the HARQ state for an indefinite period of time. This may not account for the possibility that the UE and a network node can go out-of-sync with one another. For example, the UE may fail to receive DCI transmitted by the network node that includes an NDI and that indicates a change to the HARQ state. In the example of uplink HARQ, the UE may receive first DCI that includes a first NDI, and may perform a new transmission (for example, transmit a communication for a first time) in accordance with the first NDI. At a subsequent time, the UE may receive second DCI that includes a second NDI, the second NDI being different than the first NDI, and may perform one or more retransmissions of the communication in accordance with the second NDI. At another subsequent time, the network node may transmit third DCI that includes a third NDI, the third NDI being different than the second NDI. However, the UE may not receive the third NDI. Thus, the UE may continue to retransmit the communication even though the network node has already received the communication from the UE. This may result in wasted network resources, for example, due to the UE performing unnecessary retransmissions of the communication. Additionally or alternatively, this may result in missed transmission opportunities by the UE since the UE may not perform any new transmissions while the UE is retransmitting the communication that has already been received by the network node.

Various aspects relate generally to HARQ state discarding. Some aspects more specifically relate to selectively discarding a HARQ state in association with a HARQ state retention timer or DCI misdetection information. In some aspects, the UE may initiate a HARQ state retention timer that indicates a time period during which the UE is to retain the HARQ state. For example, the UE may maintain the HARQ state in a high state, and may perform one or more retransmissions of a communication, for a duration of the HARQ state retention timer. The UE may discard the HARQ state in association with an expiration of the HARQ state retention timer. In some aspects, the UE may identify DCI misdetection information. The DCI misdetection information may indicate a likelihood that the UE did not receive first DCI transmitted by the network node. The DCI misdetection information may be based at least in part on an energy parameter, a cyclic redundancy check parameter, or a prune parameter, among other examples. The UE may discard the HARQ state in association with the likelihood that the UE did not receive the first DCI being greater than a threshold. In some aspects, the UE may receive second DCI that includes an NDI, and may transmit a communication in association with selectively discarding the HARQ state and receiving the DCI. For example, the UE may perform one or more retransmissions of a communication in association with discarding the HARQ state and in accordance with the NDI indicating to perform the one or more retransmissions. Alternatively, the UE may transmit a new communication in association with discarding the HARQ state and in accordance with the NDI indicating to perform the new transmission.

Particular aspects of the subject matter described in this disclosure can be implemented to realize one or more of the following potential advantages. In some examples, the described techniques can be used to improve HARQ state synchronization between the UE and the network node. For example, the UE may discard a HARQ state and, therefore, may transmit a new communication rather than perform one or more retransmissions of a communication that has previously been received by the network node, in association with a HARQ state retention timer or DCI misdetection information. This may reduce a number of wasted network resources resulting from retransmissions of communications that have already been received by the network node. Additionally or alternatively, this may increase a number of new communications that can be transmitted by the UE.

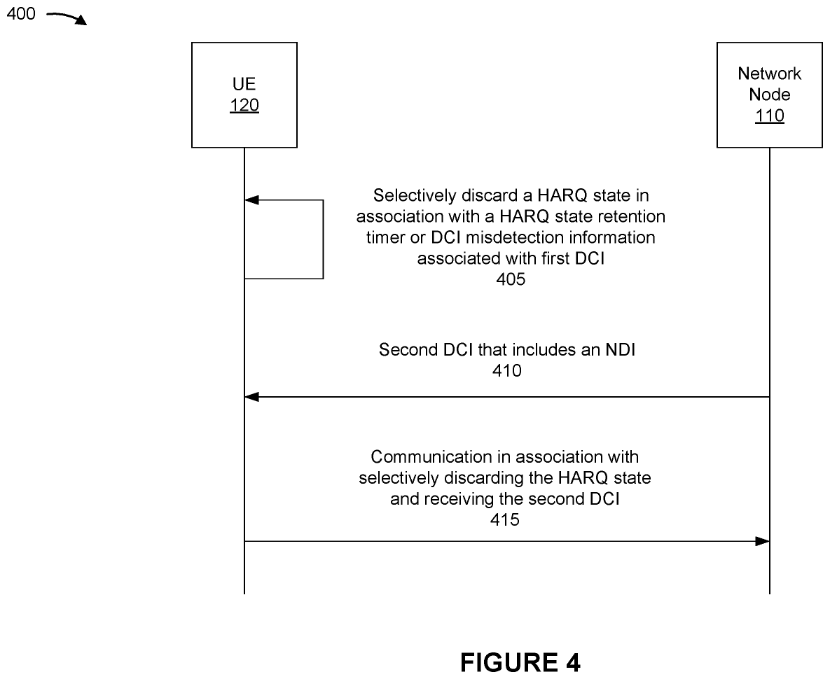

FIG. 4 is a diagram illustrating an example 400 of HARQ state discarding, in accordance with the present disclosure.

In an operation associated with reference number 405, the UE 120 may selectively discard a HARQ state. The HARQ state may be in association with first DCI from the network node 110. For example, the UE 120 may receive first DCI that includes an NDI value, and may set the HARQ state to a first state or a second state in association with the NDI value. In some aspects, the UE 120 may selectively discard the HARQ state in association with a HARQ state retention timer. The UE 120 may initiate the HARQ state retention timer (for example, after receiving the first DCI) and may discard the HARQ state in association with an expiration of the HARQ state retention timer.

In some aspects, a duration of the HARQ state retention timer may be in association with a discontinuous reception (DRX) cycle of the UE 120. For example, the duration of the HARQ state retention timer (in milliseconds (ms)) may be in accordance with the following:

$$min \{ 256 / ( 2 \hat{} μ ) ms , max ( 70 ms , K \times drx - LongCycle ( ms ) - 10 ) \} ,$$

where μ=0 for 15 kilohertz (kHz) sub-carrier spacing (SCS) or 1 for 30 kHz SCS;
drx-LongCycle is a duration of the DRX cycle; and K is a variable associated with a traffic type and/or a bandwidth part (BWP) configuration. For example, K may have a lower value when the traffic type is voice traffic or may have a higher value when the traffic type is non-voice traffic. Additionally or alternatively, K may have a higher value for a sparse BWP configuration or may have a lower value for a non-sparse (for example, dense) BWP configuration.

In some aspects, a duration of the HARQ state retention timer may be a fixed value. For example, the duration of the HARQ state retention timer may be a fixed value of X ms in association with the UE 120 not being configured with a DRX cycle and/or in association with 120 kHz SCS communications. A value of X may be in association with a delay associated with one or more previous uplink transmissions by the UE 120.

Additionally, or alternatively, the duration of the HARQ state retention timer may in some aspects be based at least in part on a quantity of PUSCH repetitions configured for the UE 120. That is, the duration of the HARQ state retention timer may in some aspects depend on a quantity of PUSCH repetitions that the UE 120 is configured to transmit (e.g., a higher quantity of PUSCH repetitions may enable a shorter duration for the HARQ state retention timer).

Additionally, or alternatively, the duration of the HARQ state retention timer may in some aspects be based at least in part on a period of a configured grant (CG). That is, the duration of the HARQ state retention timer may in some aspects depend on a period of a CG configured for the UE 120.

In some aspects, the UE 120 may start the HARQ state retention timer in association with receiving the first DCI from the network node 110. The UE 120 may retain the HARQ state for a time period (such as two DRX cycles) and may discard the HARQ state upon an expiration of the HARQ state retention timer or a time that is prior to the expiration of the HARQ state retention timer (for example, 10 ms before an end of the second DRX cycle).

In some aspects, the HARQ state retention timer may be in association with a packet type. The UE 120 may start the HARQ state retention timer in association with receiving a packet. The UE 120 may determine a packet lifetime and/or a packet validity in accordance with a jitter requirement for the packet type. After an expiration of the HARQ state retention timer, the UE 120 may discard the HARQ state since there may be no need to retransmit the packet.

In some aspects, the HARQ state retention timer may be in association with an input from another device. For example, the HARQ state retention timer may be in association with an input from another device having a distance from the UE 120 that is greater than a distance threshold. This may be useful for voice applications (and other similar applications) with far-end de-jitter buffer controlling play-out. In some aspects, the other device may provide the UE 120 with feedback that indicates a time period for retransmitting the packet. The UE 120 may use the feedback for determining the duration of the HARQ state retention timer.

In some aspects, the UE 120 may discard the HARQ state in association with the HARQ state retention timer and in association with checking an RV. For example, the UE 120 may check for an expiration of the HARQ retention timer only if the RV is zero (RV=0), the NDI is the same as a previous NDI, and a non-reserved MCS satisfies an MCS threshold. In some aspects, the UE 120 may discard the HARQ state in association with the HARQ state retention timer and in association with a previously received DCI having a non-reserved MCS and an NDI value that is equal to a current NDI value. In some aspects, the UE 120 may discard the HARQ state in association with the HARQ state retention timer and in association with the network node 110 having previously used an RV value that is not equal to zero (RV !=0) for a new transmission.

In some aspects, the UE 120 may discard the HARQ state in association with checking one or more parameters from a received DCI (e.g., an MCS, an RV, or the like) and one or more other resource allocation parameters, such as a number of symbols or a number of RBs. For example, if the RV is 0 or if the RV !=0, but the MCS fails to satisfy (e.g., is lower than) a threshold, and the resource allocation parameter satisfies a threshold, then the UE 120 may determine that a transport block (TB) is self-decodable and may discard the HARQ state in association with the HARQ state retention timer. In an alternative example, if the RV !=0 and the MCS satisfies (e.g., is equal to or higher than) the threshold, then the UE 120 may determine that the TB is not self-decodable and may refrain from discarding the HARQ state.

In some aspects, the UE 120 may selectively discard the HARQ state in association with DCI misdetection information. The DCI misdetection information may indicate a likelihood that the UE 120 did not receive the first DCI from the network node 110. For example, in association with the UE 120 determining that the likelihood is high (for example, greater than a threshold), the UE 120 may determine to discard the HARQ state. Alternatively, in association with the UE 120 determining that the likelihood is low (for example, not greater than the threshold), the UE 120 may determine to not discard the HARQ state.

In some aspects, the DCI misdetection information may be in association with PDCCH decoding metrics, such as an energy parameter (for example, energy detected), a cyclic redundancy check (CRC) parameter (for example, a CRC fail), or a prune parameter, among other examples. In some aspects, the DCI misdetection information may be in association with a measurement gap. For example, the UE 120 may determine whether a measurement gap has occurred and may determine whether the network node 110 is performing scheduling during the measurement gap. In some aspects, the DCI misdetection information may be in association with a pattern of one or more previous RVs. For example, the UE 120 may determine whether a transmission is to be a retransmission or a new transmission in association with the pattern of the one or more previous RVs.

In some aspects, discarding the HARQ state may be limited to voice traffic. For example, the UE 120 may only discard the HARQ state, in association with the HARQ state retention timer or the DCI misdetection information, in association with a communication being a voice call. In this example, two DRX cycles of the UE 120 may be sufficient for improving voice performance while minimizing end-to-end delay. A HARQ state retention timer for voice traffic may have an upper bound of 256 slots, for example, since voice traffic may not use higher values of the drx-LongCycle. In some aspects, discarding the HARQ state may be limited to non-millimeter-wave (mmW) traffic. For example, the UE 120 may not discard a HARQ state associated with mmW traffic, such as mmW voice traffic, even after an expiration of the HARQ state retention timer or the UE 120 determining that the likelihood of missing the first DCI is greater than the threshold. In some aspects, discarding the HARQ state may be limited to a sparse PDCCH BWP configuration. For example, the UE 120 may not discard the HARQ state for a PDCCH BWP configuration having a density that is greater than a threshold. In some aspects, discarding the HARQ state may be limited to an RLC unacknowledged mode (UM) configuration or a specific TB/HARQ process containing a UM packet.

In an operation associated with reference number 410, the network node 110 may transmit, and the UE 120 may receive, second DCI that includes an NDI. The UE 120 may receive the second DCI after discarding the HARQ state in association with the HARQ state retention timer or the DCI misdetection information associated with the first DCI. In some aspects, the UE 120 may not be configured with a HARQ state after discarding the HARQ state. In some aspects, the NDI may be a bit or may include a bit. The UE 120 may determine a HARQ state (for example, a subsequent HARQ state) in association with the NDI. For example, the UE 120 may determine that the subsequent HARQ state is to be in the high state in association with the NDI having a first value, or may determine that the subsequent HARQ state is to be in the low state in association with the NDI having a second value.

In an operation associated with reference number 415, the UE 120 may transmit, and the network node 110 may receive, a communication in association with selectively discarding the HARQ state and receiving the DCI. In one example, the UE 120 may transmit a new communication in association with discarding the HARQ state and in association with the subsequent HARQ state being in a low state. In another example, the UE 120 may perform one or more retransmissions of a communication in association with discarding the HARQ state and in association with the subsequent HARQ state being in a high state. In another example, the UE 120 may perform one or more retransmissions of a communication in association with the HARQ state not being discarded or in association with the NDI received via the second DCI being the same as a current NDI stored by the UE 120 prior to receiving the second DCI. In some aspects, the UE 120 may initiate a HARQ state discard timer at a time that is after receiving the second DCI. For example, the UE 120 may initiate the HARQ state discard timer in association with receiving the second DCI. The UE 120 may compare the NDI received via the second DCI with the current NDI stored by the UE 120 prior to receiving the second DCI. If the NDI received via the second DCI is the same as the current NDI stored by the UE 120, the UE 120 may discard the HARQ state in association with an expiration of the HARQ state discard timer.

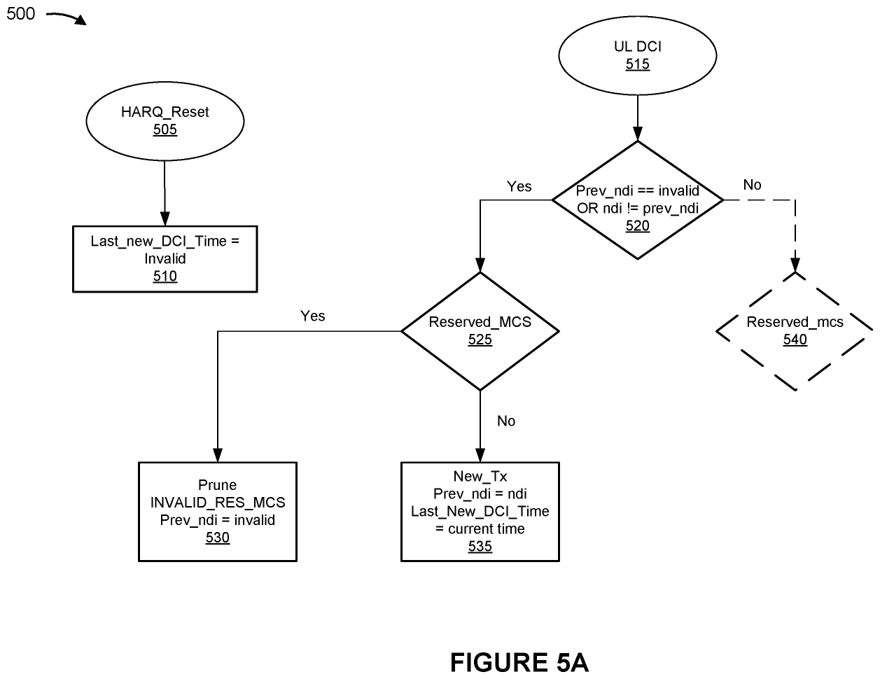

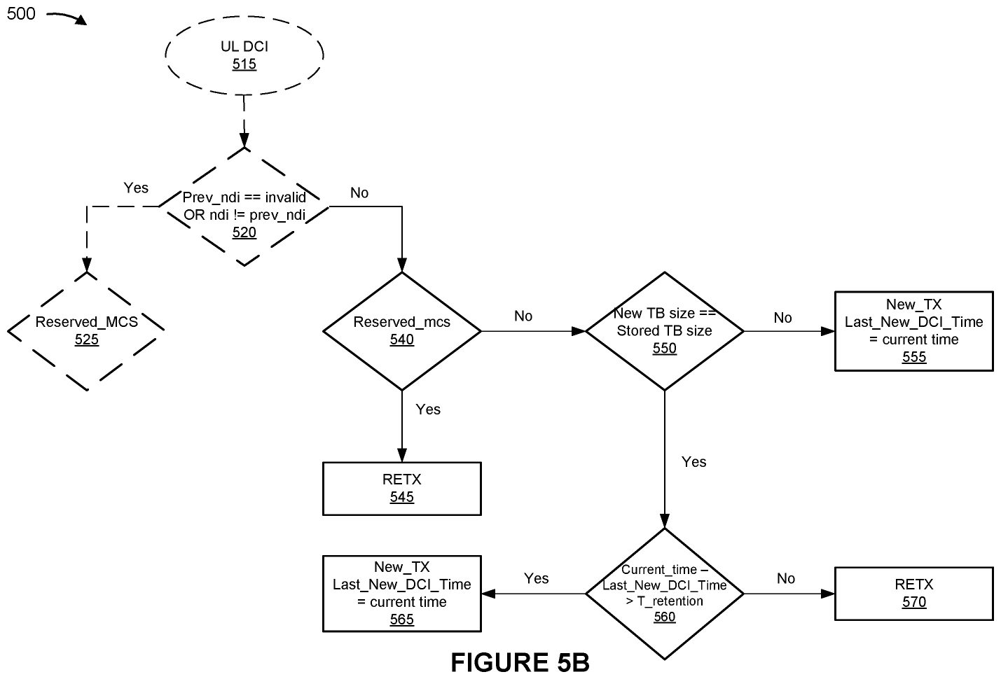

FIGS. 5A-5B are diagrams illustrating an example process 500 for a HARQ state retention timer, in accordance with the present disclosure.

As shown in FIG. 5A, in an operation associated with reference number 505, the UE 120 may identify a HARQ reset (HARQ_Reset). In an operation associated with reference number 510, the UE 120 may determine that a last new DCI time is invalid (Last_new_DCI_Time=Invalid).

In an operation associated with reference number 515, the UE 120 may receive uplink (UL) DCI. In an operation associated with reference number 520, the UE 120 may determine whether a previous NDI value is invalid (prev_ndi==invalid) or whether a current NDI value is not equal to a previous NDI value (ndi !=prev_ndi). In an operation associated with reference number 525, if the previous NDI value is invalid and/or the current NDI value is not equal to the previous NDI value, the UE 120 may determine whether a first reserved MCS (reserved_MCS) is valid. In an operation associated with reference number 530, if the first reserved MCS is valid, the UE 120 may prune an invalid reserved MCS (Prune INVALID_RES_MCS), and a previous NDI value may be determined to be invalid (prev_ndi=invalid). In an operation associated with reference number 535, if the first reserved MCS is not valid, the UE 120 may perform a new transmission (NEW_TX), a previous NDI value may be equal to a current NDI value (prev_ndi=ndi), and a last new DCI time may be equal to a current time (Last_New_DCI_Time=current time).

As shown in FIG. 5B, in an operation associated with reference number 540, if the previous NDI value is not invalid or the current NDI value is equal to the previous NDI value, the UE 120 may determine whether a second reserved MCS (reserved_mcs) is valid. In an operation associated with reference number 545, if the second reserved MCS is valid, the UE 120 may perform a retransmission (RETX). In an operation associated with reference number 550, if the second reserved MCS is not valid, the UE 120 may determine whether a new TB size is equal to a stored TB size (new TB size==stored TB size). In an operation associated with reference number 555, if the new TB size is not equal to the stored TB size, the UE 120 may perform a new transmission (New_TX) and a last new DCI time may be equal to a current time (Last_New_DCI_Time=current time). In an operation associated with reference number 560, if the new TB size is equal to the stored TB size, the UE 120 may determine whether a current time minus a last new DCI time is greater than a retention time (Current_time-Last_New_DCI_Time>T_retention). In an operation associated with reference number 565, if the current time minus the last new DCI time is greater than the retention time, the UE 120 may perform a new transmission (New_TX) and a last new DCI time may be equal to a current time (Last_New_DCI_Time=current time). In an operation associated with reference number 570, if the current time minus the last new DCI time is not greater than the retention time, the UE 120 may perform a retransmission (RETX).

FIG. 6 is a flowchart illustrating an example process 600 performed, for example, by a UE that supports wireless communications in accordance with the present disclosure. Example process 600 is an example where the UE (for example, UE 120) performs operations associated with HARQ state discarding.

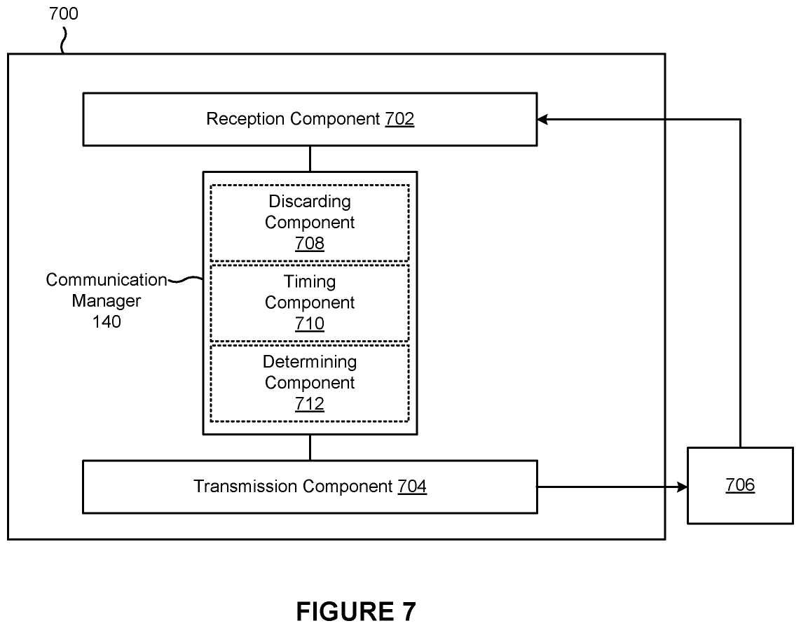

As shown in FIG. 6, in some aspects, process 600 may include selectively discarding a HARQ state in association with a HARQ state retention timer or DCI misdetection information associated with first DCI (block 610). For example, the UE (such as by using communication manager 140 or discarding component 708, depicted in FIG. 7) may selectively discard a HARQ state in association with a HARQ state retention timer or DCI misdetection information associated with first DCI, as described above.

As further shown in FIG. 6, in some aspects, process 600 may include receiving second DCI that includes an NDI (block 620). For example, the UE (such as by using communication manager 140 or reception component 702, depicted in FIG. 7) may receive second DCI that includes an NDI, as described above.

As further shown in FIG. 6, in some aspects, process 600 may include transmitting a communication in association with selectively discarding the HARQ state and receiving the second DCI (block 630). For example, the UE (such as by using communication manager 140 or transmission component 704, depicted in FIG. 7) may transmit a communication in association with selectively discarding the HARQ state and receiving the second DCI, as described above.

Process 600 may include additional aspects, such as any single aspect or any combination of aspects described below or in connection with one or more other processes described elsewhere herein.

In a first additional aspect, transmitting the communication comprises transmitting the communication for a first time in association with discarding the HARQ state and receiving the second DCI.

In a second additional aspect, alone or in combination with the first aspect, transmitting the communication comprises retransmitting the communication in association with the HARQ state not being discarded or in association with the NDI being the same as a current NDI stored by the UE.

In a third additional aspect, alone or in combination with one or more of the first and second aspects, selectively discarding the HARQ state comprises retaining the HARQ state in association with the HARQ state retention timer being active or in association with the DCI misdetection information indicating that a likelihood of the UE not receiving the first DCI is below a threshold.

In a fourth additional aspect, alone or in combination with one or more of the first through third aspects, selectively discarding the HARQ state comprises discarding the HARQ state in association with an expiration of the HARQ retention timer.

In a fifth additional aspect, alone or in combination with one or more of the first through fourth aspects, process 600 includes initiating the HARQ retention timer in association with receiving third DCI, the third DCI being received prior to the second DCI.

In a sixth additional aspect, alone or in combination with one or more of the first through fifth aspects, the HARQ retention timer is associated with a DRX cycle of the UE.

In a seventh additional aspect, alone or in combination with one or more of the first through sixth aspects, a duration of the HARQ retention timer is in association with a duration of the DRX cycle multiplied by a variable, the variable having a first value in association with the communication being a voice communication or having a second value in association with the communication being another communication that is not a voice communication.

In an eighth additional aspect, alone or in combination with one or more of the first through seventh aspects, a duration of the HARQ retention timer is associated with a fixed value.

In a ninth additional aspect, alone or in combination with one or more of the first through eighth aspects, the fixed value is in association with a delay of one or more prior retransmissions by the UE.

In a tenth additional aspect, alone or in combination with one or more of the first through ninth aspects, a duration of the HARQ retention timer is less than or equal to two DRX cycle durations.

In an eleventh additional aspect, alone or in combination with one or more of the first through tenth aspects, a duration of the HARQ retention timer is in association with a traffic type of another communication that is transmitted in association with third DCI, the third DCI being received prior to the second DCI.

In a twelfth additional aspect, alone or in combination with one or more of the first through eleventh aspects, process 600 includes initiating the HARQ retention timer in association with transmitting the other communication, and determining a lifetime or a validity of the other communication in association with a jitter requirement for the traffic type, wherein a duration of the HARQ retention timer is in association with an input from another device, the other device being at a distance from the UE that satisfies a distance threshold.

In a thirteenth additional aspect, alone or in combination with one or more of the first through twelfth aspects, selectively discarding the HARQ state comprises discarding the HARQ state in association with an expiration of the HARQ retention timer and in association with a redundancy value received via the second DCI.

In a fourteenth additional aspect, alone or in combination with one or more of the first through thirteenth aspects, discarding the HARQ state in association with the redundancy value comprises discarding the HARQ state in association with the redundancy value being equal to zero, the NDI being unchanged, and a non-reserved modulation coding scheme being greater than a modulation coding scheme threshold.

In a fifteenth additional aspect, alone or in combination with one or more of the first through fourteenth aspects, selectively discarding the HARQ state comprises discarding the HARQ state in association with third DCI having a non-reserved modulation coding scheme and an NDI that is equal to the NDI included in the second DCI, the third DCI being received prior to the second DCI.

In a sixteenth additional aspect, alone or in combination with one or more of the first through fifteenth aspects, selectively discarding the HARQ state comprises discarding the HARQ state in association with the DCI misdetection information.

In a seventeenth additional aspect, alone or in combination with one or more of the first through sixteenth aspects, the DCI misdetection information indicates a likelihood that the UE did not receive the first DCI.

In an eighteenth additional aspect, alone or in combination with one or more of the first through seventeenth aspects, process 600 includes calculating the likelihood that the UE did not receive the first DCI in association with an energy parameter, a cyclic redundancy check parameter, or a prune parameter.

In a nineteenth additional aspect, alone or in combination with one or more of the first through eighteenth aspects, the DCI misdetection information is associated with a measurement gap.

In a twentieth additional aspect, alone or in combination with one or more of the first through nineteenth aspects, transmitting the communication comprises transmitting the communication in association with selectively discarding the HARQ state, receiving the second DCI, and the communication being a voice communication.

In a twenty-first additional aspect, alone or in combination with one or more of the first through twentieth aspects, transmitting the communication comprises transmitting the communication in association with selectively discarding the HARQ state, receiving the second DCI, a physical downlink control channel monitoring configuration of a bandwidth part.

In a twenty-second additional aspect, alone or in combination with one or more of the first through twenty-first aspects, transmitting the communication comprises transmitting the communication in association with selectively discarding the HARQ state, receiving the second DCI, and a radio link control unacknowledged mode configuration.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a diagram of an example apparatus 700 for wireless communication that supports wireless communications in accordance with the present disclosure. The apparatus 700 may be a UE, or a UE may include the apparatus 700. In some aspects, the apparatus 700 includes a reception component 702, a transmission component 704, and a communication manager 140, which may be in communication with one another (for example, via one or more buses). As shown, the apparatus 700 may communicate with another apparatus 706 (such as a UE, a network node, or another wireless communication device) using the reception component 702 and the transmission component 704.

In some aspects, the apparatus 700 may be configured to and/or operable to perform one or more operations described herein in connection with FIGS. 4 and 5A-5B. Additionally or alternatively, the apparatus 700 may be configured to and/or operable to perform one or more processes described herein, such as process 600 of FIG. 6. In some aspects, the apparatus 700 may include one or more components of the UE described above in connection with FIG. 2.

The reception component 702 may receive communications, such as reference signals, control information, and/or data communications, from the apparatus 706. The reception component 702 may provide received communications to one or more other components of the apparatus 700, such as the communication manager 140. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 702 may include one or more antennas, a modem, a demodulator, a MIMO detector, a receive processor, a controller/processor, and/or a memory of the UE described above in connection with FIG. 2.

The transmission component 704 may transmit communications, such as reference signals, control information, and/or data communications, to the apparatus 706. In some aspects, the communication manager 140 may generate communications and may transmit the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, and/or a memory of the UE described above in connection with FIG. 2. In some aspects, the transmission component 704 may be co-located with the reception component 702 in a transceiver.

The communication manager 140 may selectively discard a HARQ state in association with a HARQ state retention timer or DCI misdetection information associated with first DCI. The communication manager 140 may receive or may cause the reception component 702 to receive second DCI that includes an NDI. The communication manager 140 may transmit or may cause the transmission component 704 to transmit a communication in association with selectively discarding the HARQ state and receiving the second DCI. In some aspects, the communication manager 140 may perform one or more operations described elsewhere herein as being performed by one or more components of the communication manager 140.

The communication manager 140 may include a controller/processor, and/or a memory of the UE described above in connection with FIG. 2. In some aspects, the communication manager 140 includes a set of components, such as a discarding component 708, a timing component 710, and/or a determining component 712. Alternatively, the set of components may be separate and distinct from the communication manager 140. In some aspects, one or more components of the set of components may include or may be implemented within a controller/processor, and/or a memory of the UE described above in connection with FIG. 2.

Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The discarding component 708 may selectively discard a HARQ state in association with a HARQ state retention timer or DCI misdetection information associated with first DCI. The reception component 702 may receive second DCI that includes an NDI. The transmission component 704 may transmit a communication in association with selectively discarding the HARQ state and receiving the second DCI. The timing component 710 may initiate the HARQ retention timer in association with receiving third DCI, the third DCI being received prior to the second DCI. The timing component 710 may initiate the HARQ retention timer in association with transmitting the other communication. The determining component 712 may determine a lifetime or a validity of the other communication in association with a jitter requirement for the traffic type, wherein a duration of the HARQ retention timer is in association with an input from another device, the other device being at a distance from the UE that satisfies a distance threshold. The determining component 712 may calculate the likelihood that the UE did not receive the first DCI in association with an energy parameter, a cyclic redundancy check parameter, or a prune parameter.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally or alternatively, a set of (one or more) components shown in FIG. 7 may perform one or more functions described as being performed by another set of components shown in FIG. 7.

The following provides an overview of some Aspects of the present disclosure:
Aspect 1: A method of wireless communication performed by a user equipment (UE), comprising: selectively discarding a hybrid automatic repeat request (HARQ) state in association with a HARQ state retention timer or downlink control information (DCI) misdetection information associated with first DCI; receiving second DCI that includes a new data indicator (NDI); and transmitting a communication in association with selectively discarding the HARQ state and receiving the second DCI.
Aspect 2: The method of Aspect 1, wherein transmitting the communication comprises transmitting the communication for a first time in association with discarding the HARQ state and receiving the second DCI.
Aspect 3: The method of any of Aspects 1-2, wherein transmitting the communication comprises retransmitting the communication in association with the HARQ state not being discarded or in association with the NDI being the same as a current NDI stored by the UE.
Aspect 4: The method of any of Aspects 1-3, wherein selectively discarding the HARQ state comprises retaining the HARQ state in association with the HARQ state retention timer being active or in association with the DCI misdetection information indicating that a likelihood of the UE not receiving the first DCI is below a threshold.
Aspect 5: The method of any of Aspects 1-4, wherein selectively discarding the HARQ state comprises discarding the HARQ state in association with an expiration of the HARQ retention timer.
Aspect 6: The method of Aspect 5, further comprising initiating the HARQ retention timer in association with receiving third DCI, the third DCI being received prior to the second DCI.
Aspect 7: The method of Aspect 5, wherein the HARQ retention timer is associated with a discontinuous reception (DRX) cycle of the UE.
Aspect 8: The method of Aspect 7, wherein a duration of the HARQ retention timer is in association with a duration of the DRX cycle multiplied by a variable, the variable having a first value in association with the communication being a voice communication or having a second value in association with the communication being another communication that is not a voice communication.
Aspect 9: The method of Aspect 5, wherein a duration of the HARQ retention timer is associated with a fixed value.
Aspect 10: The method of Aspect 9, wherein the fixed value is in association with a delay of one or more prior retransmissions by the UE.
Aspect 11: The method of Aspect 5, wherein a duration of the HARQ retention timer is less than or equal to two discontinuous reception (DRX) cycle durations.
Aspect 12: The method of Aspect 5, wherein a duration of the HARQ retention timer is in association with a traffic type of another communication that is transmitted in association with third DCI, the third DCI being received prior to the second DCI.
Aspect 13: The method of Aspect 12, further comprising: initiating the HARQ retention timer in association with transmitting the other communication; and determining a lifetime or a validity of the other communication in association with a jitter requirement for the traffic type, wherein a duration of the HARQ retention timer is in association with an input from another device, the other device being at a distance from the UE that satisfies a distance threshold.
Aspect 14: The method of Aspect 5, wherein selectively discarding the HARQ state comprises discarding the HARQ state in association with an expiration of the HARQ retention timer and in association with a redundancy value received via the second DCI.
Aspect 15: The method of Aspect 14, wherein discarding the HARQ state in association with the redundancy value comprises discarding the HARQ state in association with the redundancy value being equal to zero, the NDI being unchanged, and a non-reserved modulation coding scheme being greater than a modulation coding scheme threshold.
Aspect 16: The method of Aspect 5, wherein selectively discarding the HARQ state comprises discarding the HARQ state in association with third DCI having a non-reserved modulation coding scheme and an NDI that is equal to the NDI included in the second DCI, the third DCI being received prior to the second DCI.
Aspect 17: The method of any of Aspects 1-16, wherein selectively discarding the HARQ state comprises discarding the HARQ state in association with the DCI misdetection information.
Aspect 18: The method of Aspect 17, wherein the DCI misdetection information indicates a likelihood that the UE did not receive the first DCI.
Aspect 19: The method of Aspect 18, further comprising calculating the likelihood that the UE did not receive the first DCI in association with an energy parameter, a cyclic redundancy check parameter, or a prune parameter.
Aspect 20: The method of Aspect 17, wherein the DCI misdetection information is associated with a measurement gap.
Aspect 21: The method of any of Aspects 1-20, wherein transmitting the communication comprises transmitting the communication in association with selectively discarding the HARQ state, receiving the second DCI, and the communication being a voice communication.
Aspect 22: The method of any of Aspects 1-21, wherein transmitting the communication comprises transmitting the communication in association with selectively discarding the HARQ state, receiving the second DCI, a physical downlink control channel monitoring configuration of a bandwidth part.
Aspect 23: The method of any of Aspects 1-22, wherein transmitting the communication comprises transmitting the communication in association with selectively discarding the HARQ state, receiving the second DCI, and a radio link control unacknowledged mode configuration.
Aspect 24: An apparatus for wireless communication at a device, comprising a processor; memory coupled with the processor; and instructions stored in the memory and executable by the processor to cause the apparatus to perform the method of one or more of Aspects 1-23.
Aspect 25: A device for wireless communication, comprising a memory and one or more processors coupled to the memory, the one or more processors configured to perform the method of one or more of Aspects 1-23.
Aspect 26: An apparatus for wireless communication, comprising at least one means for performing the method of one or more of Aspects 1-23.
Aspect 27: A non-transitory computer-readable medium storing code for wireless communication, the code comprising instructions executable by a processor to perform the method of one or more of Aspects 1-23.
Aspect 28: A non-transitory computer-readable medium storing a set of instructions for wireless communication, the set of instructions comprising one or more instructions that, when executed by one or more processors of a device, cause the device to perform the method of one or more of Aspects 1-23.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. A method of wireless communication performed by a user equipment (UE), comprising:
selectively discarding a hybrid automatic repeat request (HARQ) state in association with a HARQ state retention timer or downlink control information (DCI) misdetection information associated with first DCI;
receiving second DCI that includes a new data indicator (NDI); and
transmitting a communication in association with selectively discarding the HARQ state and receiving the second DCI.

2. The method of claim 1, wherein transmitting the communication comprises transmitting the communication for a first time in association with discarding the HARQ state and receiving the second DCI.

3. The method of claim 1, wherein transmitting the communication comprises retransmitting the communication in association with the HARQ state not being discarded or in association with the NDI being the same as a current NDI stored by the UE.

4. The method of claim 1, wherein selectively discarding the HARQ state comprises retaining the HARQ state in association with the HARQ state retention timer being active or in association with the DCI misdetection information indicating that a likelihood of the UE not receiving the first DCI is below a threshold.

5. The method of claim 1, wherein selectively discarding the HARQ state comprises discarding the HARQ state in association with an expiration of the HARQ retention timer.

6. The method of claim 5, further comprising initiating the HARQ retention timer in association with receiving third DCI, the third DCI being received prior to the second DCI.

7. The method of claim 5, wherein the HARQ retention timer is associated with a discontinuous reception (DRX) cycle of the UE.

8. The method of claim 7, wherein a duration of the HARQ retention timer is in association with a duration of the DRX cycle multiplied by a variable, the variable having a first value in association with the communication being a voice communication or having a second value in association with the communication being another communication that is not a voice communication.

9. The method of claim 5, wherein a duration of the HARQ retention timer is associated with a fixed value.

10. The method of claim 9, wherein the fixed value is in association with a delay of one or more prior retransmissions by the UE.

11. The method of claim 5, wherein a duration of the HARQ retention timer is less than or equal to two discontinuous reception (DRX) cycle durations.

12. The method of claim 5, wherein a duration of the HARQ retention timer is in association with a traffic type of another communication that is transmitted in association with third DCI, the third DCI being received prior to the second DCI.

13. The method of claim 12, further comprising:
initiating the HARQ retention timer in association with transmitting the other communication; and
determining a lifetime or a validity of the other communication in association with a jitter requirement for the traffic type, wherein a duration of the HARQ retention timer is in association with an input from another device, the other device being at a distance from the UE that satisfies a distance threshold.

14. The method of claim 5, wherein selectively discarding the HARQ state comprises discarding the HARQ state in association with an expiration of the HARQ retention timer and in association with a redundancy value received via the second DCI.

15. The method of claim 14, wherein discarding the HARQ state in association with the redundancy value comprises discarding the HARQ state in association with the redundancy value being equal to zero, the NDI being unchanged, and a non-reserved modulation coding scheme being greater than a modulation coding scheme threshold.

16. The method of claim 5, wherein selectively discarding the HARQ state comprises discarding the HARQ state in association with third DCI having a non-reserved modulation coding scheme and an NDI that is equal to the NDI included in the second DCI, the third DCI being received prior to the second DCI.

17. The method of claim 1, wherein selectively discarding the HARQ state comprises discarding the HARQ state in association with the DCI misdetection information.

18. The method of claim 17, wherein the DCI misdetection information indicates a likelihood that the UE did not receive the first DCI.

19. The method of claim 18, further comprising calculating the likelihood that the UE did not receive the first DCI in association with an energy parameter, a cyclic redundancy check parameter, or a prune parameter.

20. The method of claim 17, wherein the DCI misdetection information is associated with a measurement gap.

21. The method of claim 1, wherein transmitting the communication comprises transmitting the communication in association with selectively discarding the HARQ state, receiving the second DCI, and the communication being a voice communication.

22. The method of claim 1, wherein transmitting the communication comprises transmitting the communication in association with selectively discarding the HARQ state, receiving the second DCI, a physical downlink control channel monitoring configuration of a bandwidth part.

23. The method of claim 1, wherein transmitting the communication comprises transmitting the communication in association with selectively discarding the HARQ state, receiving the second DCI, and a radio link control unacknowledged mode configuration.

24. A user equipment (UE) for wireless communication, comprising:
at least one memory; and
at least one processor communicatively coupled with the at least one memory, the at least one processor operable to cause the UE to:
selectively discard a hybrid automatic repeat request (HARQ) state in association with a HARQ state retention timer or downlink control information (DCI) misdetection information associated with first DCI;
receive second DCI that includes a new data indicator (NDI); and
transmit a communication in association with selectively discarding the HARQ state and receiving the second DCI.

25. The UE of claim 24, wherein, to cause the UE to transmit the communication, the at least one processor is operable to cause the UE to transmit the communication for a first time in association with discarding the HARQ state and receiving the second DCI.

26. The UE of claim 24, wherein, to cause the UE to transmit the communication, the at least one processor is operable to cause the UE to retransmit the communication in association with the HARQ state not being discarded or in association with the NDI being the same as a current NDI stored by the UE.

27. The UE of claim 24, wherein, to cause the UE to selectively discard the HARQ state, the at least one processor is operable to cause the UE to retain the HARQ state in association with the HARQ state retention timer being active or in association with the DCI misdetection information indicating that a likelihood of the UE not receiving the first DCI is below a threshold.

28. The UE of claim 24, wherein, to cause the UE to selectively discard the HARQ state, the at least one processor is operable to cause the UE to discard the HARQ state in association with an expiration of the HARQ retention timer.

29. A non-transitory computer-readable medium storing a set of instructions for wireless communication, the set of instructions comprising:
one or more instructions that, when executed by one or more processors of a user equipment (UE), cause the UE to:
selectively discard a hybrid automatic repeat request (HARQ) state in association with a HARQ state retention timer or downlink control information (DCI) misdetection information associated with first DCI;
receive second DCI that includes a new data indicator (NDI); and
transmit a communication in association with selectively discarding the HARQ state and receiving the second DCI.

30. An apparatus for wireless communication, comprising:
means for selectively discarding a hybrid automatic repeat request (HARQ) state in association with a HARQ state retention timer or downlink control information (DCI) misdetection information associated with first DCI;
means for receiving second DCI that includes a new data indicator (NDI); and
means for transmitting a communication in association with selectively discarding the HARQ state and receiving the second DCI.
